(19) United States
(12) Patent Application Publication
(10) Pub. No.: US 2026/0313695 A1
(43) Pub. Date: Oct. 8, 2026

(54) METHOD AND APPARATUS FOR ENTITY IN A WIRELESS COMMUNICATION SYSTEM

(71) Applicant: Samsung Electronics Co., Ltd., Gyeonggi-do (KR)

(72) Inventors: Yanru WANG, Beijing (CN); Lixiang XU, Beijing (CN); Hong WANG, Beijing (CN); Weiwei WANG, Beijing (CN)

(21) Appl. No.: 18/998,454

(22) PCT Filed: Jul. 28, 2023
(86) PCT No.: PCT/KR2023/011081

§ 371 Date: Jan. 24, 2025

(30) Foreign Application Priority Data
Jul. 29, 2022 (CN) 202210907688.6
Jun. 29, 2023 (CN) 202310787780.8

(51) Int. Cl. H04W 74/0833

(52) U.S. Cl. CPC H04W 74/0833

(57) ABSTRACT

The disclosure relates to a 5G or 6G communication system for supporting a higher data transmission rate. Specifically, the disclosure related to method performed by a first entity in a wireless communication system according to embodiments of the present disclosure may include: transmitting, to a second entity, at least one piece of information of first information including small data transmission (SDT) information for SDT based on SDT configuration information, second information including random access channel (RACH) partition random access information for random access based on RACH partition configuration information, and fifth information including the SDT configuration information and/or the RACH partition configuration information, wherein the at least one piece of information is associated with at least one of the first entity and other entities except the first entity. The methods performed by the first entity and/or the second entity in the wireless communication system provided by the present disclosure enable self-optimizing decision-making or configuration updating at the network side by exchanging information related to random access and/or the like between entities.

### TECHNICAL FIELD

The present disclosure relates to a technical field of wireless communication, and more specifically, the present disclosure relates to method and apparatus for an entity in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mm Wave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user con-venience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial In-telligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The present disclosure relates to a technical field of wireless communication, and more specifically, the present disclosure relates to method and apparatus for an entity in a wireless communication system.

### Solution to Problem

Embodiments of the present disclosure provide a method performed by a first entity in a wireless communication system, including: transmitting, to a second entity, at least one piece of information of first information including small data transmission (SDT) information for SDT based on SDT configuration information, second information including random access channel (RACH) partition random access information for random access based on RACH partition configuration information, and fifth information including the SDT configuration information and/or the RACH partition configuration information, wherein the at least one piece of information is associated with at least one of the first entity and other entities except the first entity.

Embodiments of the present disclosure provide a method performed by a second entity in a wireless communication system, including: receiving, from a first entity, at least one piece of information of first information including small data transmission (SDT) information for SDT based on SDT configuration information, second information including random access channel (RACH) partition random access information for random access based on RACH partition configuration information, and fifth information including the SDT configuration information and/or the RACH partition configuration information, wherein the at least one piece of information is associated with at least one of the first entity and other entities except the first entity.

Embodiments of the present disclosure provide a first entity device in a wireless communication system, including a transceiver configured to transmit and receive signals; and a processor coupled to the transceiver and configured to perform the methods performed by the first entity in the wireless communication system according to embodiments of the present disclosure.

Embodiments of the present disclosure provide a second entity device in a wireless communication system, including a transceiver configured to transmit and receive signals; and a processor coupled to the transceiver and configured to perform the methods performed by the second entity in the wireless communication system according to embodiments of the present disclosure.

Embodiments of the present disclosure provide a computer-readable medium having stored thereon computer-readable instructions which, when performed by a processor, are used to implement the methods performed by the first entity and/or the second entity in the wireless communication system according to embodiments of the present disclosure.

The methods performed by the first entity and/or the second entity in the wireless communication system provided by the present disclosure enable self-optimizing decision-making or configuration updating at the network side by exchanging information related to random access and/or the like between entities.

### BRIEF DESCRIPTION OF DRAWINGS

The above and other aspects, features and advantages of certain embodiments of the present disclosure will be more apparent from the following description taken in con-junction with the accompanying drawings, in which:

FIG. 1 illustrates an example of system architecture of system architecture evolution (SAE) according to various embodiments of the present disclosure;

FIG. 2 illustrates an example of system architecture according to various embodiments of the present disclosure;

FIG. 3 illustrates a flowchart of a method performed by a first entity in a wireless communication system according to various embodiments of the present disclosure;

FIG. 4 illustrates a flowchart of a method performed by a second entity in a wireless communication system according to various embodiments of the present disclosure;

FIG. 5 illustrates a schematic diagram of a method for supporting network self-optimization according to various embodiments of the present disclosure;

FIG. 6 illustrates a schematic diagram of a method for supporting network self-optimization according to various embodiments of the present disclosure;

FIG. 7 illustrates a schematic diagram of a method for supporting network self-optimization according to various embodiments of the present disclosure;

FIG. 8 illustrates a schematic diagram of a method for supporting network self-optimization according to various embodiments of the present disclosure;

FIG. 9 illustrates a schematic diagram of a method for supporting network self-optimization according to various embodiments of the present disclosure;

FIG. 10 illustrates a schematic diagram of a method for supporting network self-optimization according to various embodiments of the present disclosure;

FIG. 11 illustrates a schematic diagram of a method for supporting network self-optimization according to various embodiments of the present disclosure;

FIG. 12 illustrates a schematic diagram of a method for supporting network self-optimization according to various embodiments of the present disclosure;

FIG. 13 illustrates a schematic diagram of a method for supporting network self-optimization according to various embodiments of the present disclosure;

FIG. 14 illustrates a schematic diagram of a first entity according to various embodiments of the present disclosure;

FIG. 15 illustrates a schematic diagram of a second entity according to various embodiments of the present disclosure;

FIG. 16 illustrates a block diagram of a terminal (or a user equipment (UE), according to embodiments of the present disclosure; and

FIG. 17 illustrates a block diagram of a base station, according to embodiments of the present disclosure.

### MODE FOR THE INVENTION

In order to meet an increasing demand for wireless data communication services since a deployment of 4G communication system, efforts have been made to develop an improved 5G or pre- 5G communication system. Therefore, the 5G or pre-5G communication system is also called “beyond 4G network” or “post LTE system”.

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

In a random access process, small data may be transmitted in a Message A (MSGA) or a Message 3 (MSG3).

Random access resources may be partitioned according to different features (for example, Reduced Capability (RedCap), slice, small data transmission, coverage enhancement, etc.).

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

Embodiments of the present disclosure provide a method performed by a first entity in a wireless communication system, including: transmitting, to a second entity, at least one piece of information of first information including small data transmission (SDT) information for SDT based on SDT configuration information, second information including random access channel (RACH) partition random access information for random access based on RACH partition configuration information, and fifth information including the SDT configuration information and/or the RACH partition configuration information, wherein the at least one piece of information is associated with at least one of the first entity and other entities except the first entity.

According to embodiments of the present disclosure, the method performed by the first entity in the wireless communication system further includes: receiving, from the second entity, fourth information including a request for the SDT information and/or the RACH partition random access information, wherein the first information and/or the second information are transmitted by the first entity to the second entity based on the fourth information.

According to embodiments of the present disclosure, the method performed by the first entity in the wireless communication system further includes: transmitting, to the second entity, third information indicating that the SDT information is available and/or the RACH partition random access information is available, wherein the fourth information is transmitted by the first entity to the second entity based on the third information.

According to embodiments of the present disclosure, the method performed by the first entity in the wireless communication system further includes: receiving, from the second entity, SDT configuration information and/or RACH partition configuration information associated with the second entity, wherein at least part of the SDT configuration information and/or RACH partition configuration information associated with the second entity is determined by the second entity based on the fifth information.

According to embodiments of the present disclosure, the at least one piece of information is used for at least one of the first entity and the second entity to make a network self-optimization decision, wherein the network self-optimization decision includes at least one of network energy saving, load balancing, coverage optimization, mobility optimization and/or management, network configuration formulation and/or network configuration updating.

According to embodiments of the present disclosure, the first information includes one or more of: user equipment identification, node identification, cell identification, indication that a random access is for a purpose of SDT, SDT configuration information for a random access, a time from a random access to information reporting, a time from an SDT start to information reporting, a time from an SDT radio link failure to information reporting, a time from an SDT interruption to information reporting, a time from an SDT failure to information reporting, a signal quality at a time of SDT failure, a remaining data volume after SDT failure, a signal quality at a time of random access, a data volume at a time of random access, data volume when SDT starts, data volume related information in a SDT transmission process, a data volume transmitted via SDT, a remaining data volume after SDT transmission, a time from an SDT start to an SDT end, a time from an SDT start to a radio link failure, an SDT timer status at a time of SDT end, an SDT timer status at a time of radio link failure, an SDT end cause and an SDT failure cause.

According to embodiments of the present disclosure, the data volume related information in a SDT transmission process includes one or more of: an arrived data volume in a SDT transmission process, a maximum data volume in a SDT transmission process, a minimum data volume in a SDT transmission process and an average data volume in a SDT transmission process.

According to embodiments of the present disclosure, the second information includes one or more of: user equipment identification, node identification, cell identification, a feature priority, a RACH partition configuration, a time from a random access to information reporting, available resources at a time of random access, a time of a random access, a time from a random access failure to information reporting, a time of a random access failure, a feature corresponding to available resources at a time of random access, a signal quality corresponding to a synchronization signal and physical broadcast channel block (SSB), a signal quality corresponding to a MSG3, and information for attempting a random access.

According to embodiments of the present disclosure, the fifth information includes one or more of: node identification, cell identification, SDT configuration information for a random access, an acceptable value and/or a range of the acceptable value of the SDT configuration information for a random access, a RACH partition configuration, an acceptable value and/or a range of the acceptable value of the RACH partition configuration.

According to embodiments of the present disclosure, the fourth information includes one or more of: a request for SDT information, a request for an SDT report, a request for RACH partition random access information, and a request for a RACH partition report.

According to embodiments of the present disclosure, the third information includes one or more of: SDT information available, SDT report available, RACH partition random access information available, and RACH partition report available.

Embodiments of the present disclosure provide a method performed by a second entity in a wireless communication system, including: receiving, from a first entity, at least one piece of information of first information including small data transmission (SDT) information for SDT based on SDT configuration information, second information including random access channel (RACH) partition random access information for random access based on RACH partition configuration information, and fifth information including the SDT configuration information and/or the RACH partition configuration information, wherein the at least one piece of information is associated with at least one of the first entity and other entities except the first entity.

According to embodiments of the present disclosure, the method performed by the second entity in the wireless communication system further includes: transmitting, to the first entity, fourth information including a request for the SDT information and/or the RACH partition random access information, wherein the first information and/or the second information are transmitted by the first entity to the second entity based on the fourth information.

According to embodiments of the present disclosure, the method performed by the second entity in the wireless communication system further includes: receiving, from the first entity, third information indicating that the SDT information is available and/ or the RACH partition random access information is available, wherein the fourth information is transmitted by the first entity to the second entity based on the third information.

According to embodiments of the present disclosure, the method performed by a second entity in the wireless communication system further includes: transmitting, to the first entity, SDT configuration information and/or RACH partition configuration information associated with the second entity, wherein at least part of the SDT configuration information and/or RACH partition configuration information associated with the second entity is determined by the second entity based on the fifth information.

According to embodiments of the present disclosure, the at least one piece of information is used for at least one of the first entity and the second entity to make a network self-optimization decision, wherein the network self-optimization decision includes at least one of network energy saving, load balancing, coverage optimization, mobility optimization and/or management, network configuration formulation and/or network configuration updating.

According to embodiments of the present disclosure, the first information includes one or more of: user equipment identification, node identification, cell identification, indication that a random access is for a purpose of SDT, SDT configuration information for a random access, a time from a random access to information reporting, a time from an SDT start to information reporting, a time from an SDT radio link failure to information reporting, a time from an SDT interruption to information reporting, a time from an SDT failure to information reporting, a signal quality at a time of SDT failure, a remaining data volume after SDT failure, a signal quality at a time of random access, a data volume at a time of random access, data volume when SDT starts, data volume related information in a SDT transmission process, a data volume transmitted via SDT, a remaining data volume after SDT transmission, a time from an SDT start to an SDT end, a time from an SDT start to a radio link failure, an SDT timer status at a time of SDT end, an SDT timer status at a time of radio link failure, an SDT end cause and an SDT failure cause.

According to embodiments of the present disclosure, the data volume related information in a SDT transmission process includes one or more of: an arrived data volume in a SDT transmission process, a maximum data volume in a SDT transmission process, a minimum data volume in a SDT transmission process and an average data volume in a SDT transmission process.

According to embodiments of the present disclosure, the second information includes one or more of: user equipment identification, node identification, cell identification, a feature priority, a RACH partition configuration, a time from a random access to information reporting, available resources at a time of random access, a time of a random access, a time from a random access failure to information reporting, a time of a random access failure, a feature corresponding to available resources at a time of random access, a signal quality corresponding to a synchronization signal and physical broadcast channel block (SSB), a signal quality corresponding to a MSG3, and information for attempting a random access.

According to embodiments of the present disclosure, the fifth information includes one or more of: node identification, cell identification, SDT configuration information for a random access, an acceptable value and/or a range of the acceptable value of the SDT configuration information for a random access, a RACH partition configuration, an acceptable value and/or a range of the acceptable value of the RACH partition configuration.

According to embodiments of the present disclosure, the fourth information includes one or more of: a request for SDT information, a request for an SDT report, a request for RACH partition random access information, and a request for a RACH partition report.

According to embodiments of the present disclosure, the third information includes one or more of: SDT information available, SDT report available, RACH partition random access information available, and RACH partition report available.

Embodiments of the present disclosure provide a first entity device in a wireless communication system, including a transceiver configured to transmit and receive signals; and a processor coupled to the transceiver and configured to perform the methods performed by the first entity in the wireless communication system according to embodiments of the present disclosure.

Embodiments of the present disclosure provide a second entity device in a wireless communication system, including a transceiver configured to transmit and receive signals; and a processor coupled to the transceiver and configured to perform the methods performed by the second entity in the wireless communication system according to embodiments of the present disclosure.

Embodiments of the present disclosure provide a computer-readable medium having stored thereon computer-readable instructions which, when performed by a processor, are used to implement the methods performed by the first entity and/or the second entity in the wireless communication system according to embodiments of the present disclosure.

The methods performed by the first entity and/or the second entity in the wireless communication system provided by the present disclosure enable self-optimizing decision-making or configuration updating at the network side by exchanging information related to random access and/or the like between entities.

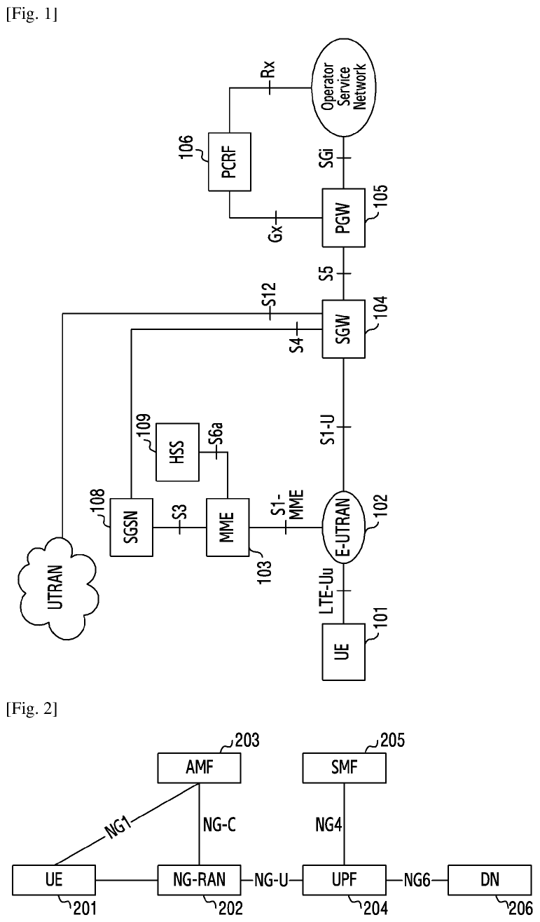

FIGS. 1 to 17 discussed below and various embodiments for describing the principles of the present disclosure in this patent document are only for illustration and should not be interpreted as limiting the scope of the present disclosure in any way. Those skilled in the art will understand that the principles of the present disclosure can be implemented in any suitably arranged system or device.

FIG. 1 illustrates an exemplary system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful in-terception, etc., and may be in the same physical entity as the SGW 104. A policy and charging rules function entity (PCRF) 106 provides quality of service (QOS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, etc.

FIG. 2 is an exemplary system architecture 200 according to various embodiments of the present disclosure. Other embodiments of the system architecture 200 can be used without departing from the scope of the present disclosure.

User equipment (UE) 201 is a terminal device for receiving data. A next generation radio access network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties.

Entities and/or nodes mentioned in the present disclosure may include gNB, gNB Central Unit (gNB-CU), gNB Distributed Unit (gNB-DU), gNB-CU-Control Plane (gNB CU-CP), gNB-CU-User Plane (gNB CU-UP), en-gNB, eNB, ng-eNB, UE, Access and Mobility Management Function (AMF), Session Management Function (SMF), Mobility Management Entity (MME) and other network entities or network logic units.

The signal strength and/or signal quality mentioned in the present disclosure may be a Received Signal Strength Indicator (RSSI), Reference Signal Receiving Power (RSRP), Reference Signal Receiving Quality (RSRQ), Signal to Interference plus Noise Ratio (SINR), etc.

The features described in the present disclosure may include one or more of: RedCap, SDT (or smallData), slice (or slice group), Coverage Enhancement, and/or the like.

The present disclosure solves the problem that the related configuration of SDT and/or RACH partition cannot be optimized because the related information of SDT and RACH partition cannot be provided for network self-optimization in the prior art.

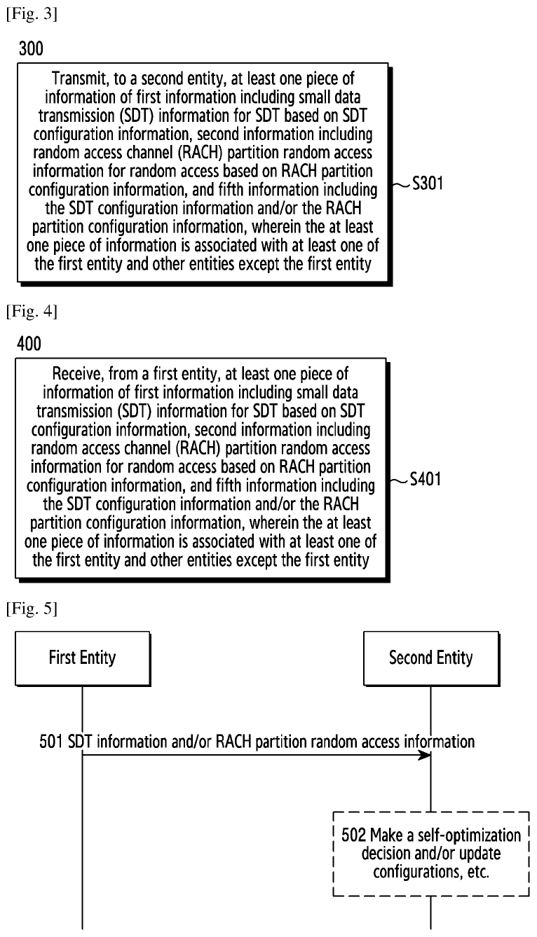

Next, FIG. 3 illustrates a flowchart of a method 300 performed by a first entity in a wireless communication system according to embodiments of the present disclosure.

As shown in FIG. 3, in operation S301, the method 300 performed by the first entity in the wireless communication system according to embodiments of the present disclosure may include that the first entity transmits to a second entity at least one piece of information of first information including small data transmission (SDT) information for SDT based on SDT configuration information, second information including random access channel (RACH) partition random access information for random access based on RACH partition configuration information, and fifth information including the SDT configuration information and/or the RACH partition configuration information. In some implementations, the at least one piece of information may be associated with at least one of the first entity and any other entity except the first entity. For example, taking the fifth information as an example, the SDT configuration information and/or RACH partition configuration information included in the fifth information transmitted by the first entity to the second entity may be SDT configuration information and/or RACH partition configuration information of the first entity itself, or SDT configuration information and/or RACH partition configuration information of any other entity collected or acquired by the first entity in any way. The other information mentioned above has the same meaning, and will not be repeated here. In addition, the first entity, the second entity and any other entity mentioned herein may be any of the above-mentioned example entities or entities newly introduced in the future, and there is no restriction herein.

In an embodiment, the method 300 may further include that the first entity receives fourth information including a request for the SDT information and/or the RACH partition random access information from the second entity. In some implementations, the first information and/or the second information described above may be transmitted by the first entity to the second entity autonomously or based on the fourth information.

In an embodiment, the method 300 may further include that the first entity transmits third information indicating that the SDT information is available and/or the RACH partition random access information is available to the second entity. In some implementations, the fourth information may be transmitted by the first entity to the second entity autonomously or based on the received third information.

In an embodiment, the method 300 may further include that the first entity receives SDT configuration information and/or RACH partition configuration information associated with the second entity from the second entity. In some implementations, some or all of the SDT configuration information and/or RACH partition configuration information associated with the second entity may be determined by the second entity based at least in part on the fifth information received from the first entity. For example, the second entity may determine part or all of the SDT configuration information and/or RACH partition configuration information associated with the second entity based on its own situation (e.g., its own capabilities and/or its own existing configuration) and/or SDT configuration information and/or RACH partition configuration information associated with the first entity and/or any other entity included in the fifth information received from the first entity.

FIG. 4 illustrates a flowchart of a method 400 performed by a second entity in a wireless communication system according to embodiments of the present disclosure.

As shown in FIG. 4, in operation S401, the method 400 performed by the second entity in the wireless communication system according to embodiments of the present disclosure may include that the second entity receives from the first entity at least one piece of information of first information including small data transmission (SDT) information for SDT based on SDT configuration information, second information including random access channel (RACH) partition random access information for random access based on RACH partition configuration information, and fifth information including the SDT configuration information and/or the RACH partition configuration information. In some implementations, the at least one piece of information may be associated with at least one of the first entity and any other entity except the first entity. For example, taking the fifth information as an example, the SDT configuration information and/or RACH partition configuration information included in the fifth information transmitted by the first entity to the second entity may be SDT configuration information and/or RACH partition configuration information of the first entity itself, or SDT configuration information and/or RACH partition configuration information of any other entity collected or acquired by the first entity in any way. The other information mentioned above has the same meaning, and will not be repeated here. In addition, the first entity, the second entity and any other entity mentioned herein may be any of the above-mentioned example entities or entities newly introduced in the future, and there is no restriction herein.

In an embodiment, the method 400 may further include that the second entity transmits fourth information including a request for the SDT information and/or the RACH partition random access information to the first entity. In some implementations, the first information and/or the second information described above may be transmitted by the first entity to the second entity autonomously or based on the fourth information.

In an embodiment, the method 400 may further include that the second entity receives third information indicating that the SDT information is available and/or the RACH partition random access information is available from the first entity. In some implementations, the fourth information may be transmitted by the first entity to the second entity autonomously or based on the received third information.

In an embodiment, the method 400 may further include that the second entity transmits SDT configuration information and/or RACH partition configuration information associated with the second entity to the first entity. In some implementations, the SDT configuration information and/or RACH partition configuration information associated with the second entity may be determined by the second entity based at least in part on the fifth information received from the first entity. For example, the second entity may determine the SDT configuration information and/or RACH partition configuration information associated with the second entity based on its own situation (e.g., its own capabilities and/or its own existing configuration) and/ or SDT configuration information and/or RACH partition configuration information associated with the first entity and/or any other entity included in the fifth information received from the first entity.

The steps or operations included in the method 300 and the method 400 according to embodiments of the present disclosure as described above may be performed individually or jointly in any combination, and may be performed in any order, for example, simultaneously or in a reverse order of the listed order. In addition, various steps or operations and various information described above will be further described below with specific examples.

Hereinafter, methods performed by a first entity and/or a second entity in a wireless communication system according to embodiments of the present disclosure will be described from various embodiments in combination with specific examples. More generally, a method performed by the first entity and/or the second entity in the wireless communication system according to embodiments of the present disclosure may also be called a method for supporting network self-optimization.

### Example 1

One embodiment of the present disclosure proposes a method for supporting network self-optimization, which may include that a first entity transmits first information including Small Data Transmission (SDT) information for SDT based on SDT configuration information to a second entity for the second entity to determine whether the SDT configuration is suitable and/or update a parameter configuration for SDT based on the received information, and/or the second entity forwards the received information to other entities for the other entities to determine whether the SDT configuration is suitable and/or update a configuration related to the SDT, so as to prevent link interruption in an SDT process and improve the robustness and effectiveness of SDT. The SDT here may be Random Access-SDT (RA-SDT) or Configured Grant-SDT (CG-SDT).

In some implementations, the first information may be included in one or more of: a user information response (UEInformationResponse), secondary cell group failure information (SCGFailureInformation), master cell group failure information (MCGFailureInformation) of Radio Resource Control (RRC); a FAILURE INDICATION message, a HANDOVER REPORT message, an ACCESS AND MOBILITY INDICATION message, an S-NODE MODIFICATION REQUEST message, an SgNB MODIFICATION REQUEST message, an SCG FAILURE INFORMATION REPORT message, a RRC TRANSFER message of Xn; an ACCESS AND MOBILITY INDICATION message of F1; an UPLINK RAN CONFIGURATION TRANSFER message and a DOWNLINK RAN CONFIGURATION TRANSFER message of NG; or an other and/or newly defined RRC and/or Xn and/or X2 and/or F1 and/or E1 and/or NG message. In some implementations, the first information may be included in a report, where the report may be a Connection Establishment Failure (CEF) report, a Random Access report, a Successful Handover report, a Radio Link Failure (RLF) report, a measurement report, or other reports related to wireless connection. The report may also be a new report, for example, a random access SDT report (RA-SDTReport) and/or random access SDT information (RA-SDTInfo) and/or SDT report (SDTReport) and/or SDT information (SDTInfo).

In some implementations, the first information may include one or more of the following fields or related information:
UE identification: it is used to identify a UE performing the random access and/or SDT.
Node identification: it is used to identify a node corresponding to the random access and/or SDT by the UE.
Cell identification: it is used to identify a cell corresponding to the random access and/or SDT by the UE.
Indication that a random access is for a purpose of SDT: it is used to identify that the purpose of the random access is for SDT. This field may be included in a random access purpose (raPurpose).
SDT configuration information for a random access: it is used to indicate the SDT configuration information applied in the random access. The information may include one or more of: a RSRP threshold corresponding to the SDT (sdt-RSRP-Threshold), a logical channel state reporting delay timer corresponding to the SDT (sdt-LogicalChannelSR-DelayTimer), a data volume threshold corresponding to the SDT (sdt-Data Volume Threshold), and an SDT timer value (for example, T319a).
A time from a random access to information reporting: it is used to indicate the time from the random access to the reporting of the first information. In an implementation, the time may be used for the node and/or entity to find related configuration, and for the node and/or entity to perform self-optimization such as configuration update on the related configuration.
A time from an SDT start to information reporting: it is used to indicate the time from the SDT start to the reporting of the first information. In an implementation, the time may be used for the node and/or entity to find related configuration, and for the node and/or entity to perform self-optimization such as configuration update on the related configuration.
A time from an SDT radio link failure to information reporting: it is used to indicate the time from the SDT radio link failure to the reporting of the first information. In an implementation, the time may be used for the node and/or entity to find related configuration, and for the node and/or entity to perform self-optimization such as configuration update on the related configuration.
A time from an SDT interruption to information reporting: it is used to indicate the time from the SDT interruption to the information reporting. In an implementation, the time may be used for the node and/or entity to find related configuration, and for the node and/or entity to perform self-optimization such as configuration update on the related configuration.
A time from an SDT failure to information reporting: it is used to indicate the time from the SDT failure to the information reporting. In an implementation, the time may be used for the node and/or entity to find related configuration, and for the node and/or entity to perform self-optimization such as configuration update on the related configuration.
A signal quality at a time of SDT failure: it is used to indicate the signal quality at a time of SDT failure. The signal quality may be RSRP, RSRQ, SINR, RSSI, etc. The SDT failure may be a radio link failure.
A remaining data volume after SDT failure: it is used to indicate the remaining untransmitted data volume after the SDT failure. The SDT failure may be a radio link failure.
A signal quality at a time of random access: it is used to indicate the signal quality at a time of random access. The signal quality may be RSRP, RSRQ, SINR, RSSI, etc.
A data volume at a time of random access: it is used to indicate the data volume when random access SDT is triggered.
A data volume when SDT starts: it is used to indicate the data volume when SDT is triggered.
Data volume related information in a SDT transmission process: it is used to indicate data volume related information in a SDT transmission process. In an implementation, the information may help a receiving node of the information to determine whether the configuration of SDT is suitable and/or how to perform adjustments (e.g., increase, decrease, etc.), for example, data volume threshold, SDT timer value (e.g., T319a), etc. The related information may include one or more of the following:
An arrived data volume in a SDT transmission process: it is used to indicate the arrived data volume in a SDT transmission process.
A maximum data volume in a SDT transmission process: it is used to indicate the buffered maximum data volume in a SDT transmission process.
A minimum data volume in a SDT transmission process: it is used to indicate the buffered minimum data volume in a SDT transmission process.
An average data volume in a SDT transmission process: it is used to indicate the buffered average data volume in a SDT transmission process.
A data volume transmitted via SDT: it is used to indicate the data volume transmitted via SDT. In an implementation, the information may help a receiving node of the information to determine whether the configuration of SDT is suitable and/or how to perform adjustments (e.g., increase, decrease, etc.), for example, data volume threshold, SDT timer value (e.g., T319a), etc.
A remaining data volume after SDT transmission: it is used to indicate the remaining untransmitted data volume after the SDT. In an implementation, the information may help a receiving node of the information to determine whether the configuration of SDT is suitable and/or how to perform adjustments (e.g., increase, decrease, etc.), for example, data volume threshold, SDT timer value (e.g., T319a), etc.
A time from an SDT start to an SDT end: it may also be a time from a T319a timer start to the SDT end. In an implementation, the time may be used for a node and/or entity to perform self-optimization such as configuration update on the related configuration. In an implementation, for example, it may be used for updating a timer (e.g., it may be T319a) in order to set a more suitable timer.
A time from an SDT start to a radio link failure: it may also be the time from the T319a timer start to the radio link failure. In an implementation, the time may be used for a node and/or entity to perform self-optimization such as configuration update on the related configuration. In an implementation, for example, it may be used for updating a timer (e.g., it may be T319a) in order to set a more suitable timer.
An SDT timer status at a time of SDT end: it indicates a status of an SDT timer at a time of SDT end. It may include running, stop, etc. The SDT timer may be the T319a. In an implementation, the status may be used for a node and/or entity to perform self-optimization such as configuration update on the related configuration. In an implementation, for example, it may be used for updating a timer (e.g., it may be T319a) in order to set a more suitable timer. In another implementation, it may be used for updating a data volume threshold corresponding to the configured SDT. For example, there may be a case that the SDT is terminated due to the stop of a timer, while the remaining data volume is small. By appropriately increasing the data volume threshold corresponding to the SDT and/or appropriately extending the timer, it is possible to avoid returning to an RRC connection state for transmission due to a small volume of remaining data.
An SDT timer status at a time of radio link failure: it indicates a status of the SDT timer at a time of radio link failure. It may include running, stop, etc. The SDT timer may be the T319a.
An SDT end cause: it indicates a reason why the SDT ends. It may include one or more of: the stop of a SDT timer (for example, the stop of T319a), the reception of a RRC message (for example, it may be a RRC release message, a RRC resume message, a RRC setup message, a RRC reject message), radio link failure, the completion of the transmission, RRC connection resume failure, etc.
An SDT failure cause: it indicates a reason why the SDT fails. It may include one or more of: the stop of a SDT timer (for example, the stop of T319a), the reception of a RRC message (for example, it may be a RRC release message, a RRC resume message, a RRC setup message, a RRC reject message), radio link failure, the completion of the transmission, RRC connection resume failure, etc.

### Example 2

One embodiment of the present disclosure proposes a method for supporting network self-optimization, which may include that a first entity transmits second information including Random Access Channel (RACH) partition random access information for random access based on RACH partition configuration information to a second entity for the second entity to determine whether a configuration of random access is suitable and/or update a parameter configuration of random access based on the received information, and/or the second entity forwards the received information to other entities for the other entities to determine whether a configuration of random access is suitable and/or update a configuration related to random access, so as to prevent random access failure caused by an unreasonable random access configuration and improve the robustness and effectiveness of random access.

In some implementations, the second information may be included in one or more of: a user information response (UEInformationResponse), secondary cell group failure information (SCGFailureInformation), master cell group failure information (MCGFailureInformation) of RRC; a FAILURE INDICATION message, a HANDOVER REPORT message, an ACCESS AND MOBILITY INDICATION message, an S-NODE MODIFICATION REQUEST message, an SgNB MODIFICATION REQUEST message, an SCG FAILURE INFORMATION REPORT message, a RRC TRANSFER message of Xn; an ACCESS AND MOBILITY INDICATION message of F1; an UPLINK RAN CONFIGURATION TRANSFER message and a DOWNLINK RAN CONFIGURATION TRANSFER message of NG; or an other and/or newly defined RRC and/or Xn and/or X2 and/or F1 and/or E1 and/or NG message. In some implementations, the second information may be included in a report, where the report may be a Connection Establishment Failure (CEF) report, a Random Access report, a Successful Handover report, a Radio Link Failure (RLF) report, a measurement report, or other reports related to wireless connection. The report may also be a new report, for example, RACH Partition Random Access Report (RA-RACHPatitionRepor) and/or RACH Partition Random Access Information Report (RA-RACHPatitionReportInfo).

In some implementations, the second information may include one or more of the following fields or related information:
UE identification: it is used to identify a UE performing the random access.
Node identification: it is used to identify a node corresponding to the random access by the UE.
Cell identification: it is used to identify a cell corresponding to the random access by the UE.
A feature priority: it is used to indicate a priority of a feature and/or a priority list of a group of features.
A RACH partition configuration: it is used to indicate the RACH partition configuration applied when performing the random access. The configuration may include one or more of:
A feature combination: it is used to indicate features the configuration is applicable to. The features may include one or more of: RedCap, SDT (or smallData), slice (or slice group), Coverage Enhancement, etc.
A start preamble for this partition (startPreambleForThisPartition)
The number of preambles for this partition (numberOfPreamblesForThisPartition)
A Synchronization Signal and PBCH (physical broadcast channel) Block (SSB) shared RACH Occasion (RO) mask index (ssb-SharedRO-MaskIndex) for this partition
The number of consecutive preambles belonging to GroupA (numberOfRA-PreamblesGroupA)
An uplink resource configuration of a MSGA: the uplink resource may be a Physical Uplink Shared Channel (PUSCH).
Feature-specific parameters: it includes one or more of: a signal quality threshold corresponding to a Synchronization Signal and PBCH (physical broadcast channel) block (SSB) (for example, it may be rsrp-ThresholdSSB), a signal quality threshold corresponding to a MSG3 (for example, it may be rsrp-ThresholdMsg3), a message power offset corresponding to GroupB (for example, it may be messagePowerOffsetGroupB), a size of random access GroupA (for example, it may be ra-SizeGroupA), and a preamble delta (deltaPreamble). The signal quality may be RSRP, RSRQ, SINR, RSSI, etc.

A time from a random access to information reporting: it is used to indicate the time from the random access to the reporting of the second information. In an implementation, the time may be used for the node and/or entity to find related configuration, and for the node and/or entity to perform self-optimization such as configuration update on the related configuration.
A time of a random access
A time from a random access failure to information reporting: it is used to indicate the time from a random access failure to the reporting of the second information. In an implementation, the time may be used for the node and/or entity to find related configuration, and for the node and/or entity to perform self-optimization such as configuration update on the related configuration.

A time of a random access failure. In an implementation, the time may be used for the node and/or entity to find related configuration, and for the node and/or entity to perform self-optimization such as configuration update on the related configuration.

Available resources at a time of random access
A feature corresponding to available resources at a time of random access
A signal quality corresponding to an SSB: the signal quality may be RSRP, RSRQ, SINR, RSSI, etc.
A signal quality corresponding to a MSG3: the signal quality may be RSRP,
RSRQ, SINR, RSSI, etc.
Information for attempting a random access: information and/or information list for each attempt in a random access process, it includes one or more of:
A RACH partition configuration
A feature priority
Feature information of a user in the random access
Attempt identification: it is used to identify this attempt.
The number of attempts: it is used to indicate the number of attempts. It indicates how many times this attempt is.
The total number of attempts: it is used to indicate the total number of attempts.
UE identification: it is used to identify a UE performing the random access.
Node identification: it is used to identify a node corresponding to the random access by the UE.
Cell identification: it is used to identify a cell corresponding to the random access by the UE.
A time from a random access to information reporting: it is used to indicate the time from the random access to the reporting of the second information. In an implementation, the time may be used for the node and/or entity to find related configuration, and for the node and/or entity to perform self-optimization such as configuration update on the related configuration.
A time of a random access
A time from a random access failure to information reporting: it is used to indicate the time from the random access failure to the reporting of the second information. In an implementation, the time may be used for the node and/or entity to find related configuration, and for the node and/or entity to perform self-optimization such as configuration update on the related configuration.
A time of a random access failure
Available resources at a time of random access
A feature corresponding to available resources at a time of random access
A signal quality corresponding to an SSB: the signal quality may be RSRP, RSRQ, SINR, RSSI, etc.
A signal quality corresponding to a MSG3: the signal quality may be RSRP, RSRQ, SINR, RSSI, etc.
Parameters at a time of random access: which may include one or more of:
A feature combination: The features may include one or more of: RedCap, SDT (or smallData), slice (or slice group), Coverage Enhancement, etc.
A start preamble for this partition (startPreambleForThisPartition)
The number of preambles for this partition (numberOfPreamblesForThisPartition)
A Synchronization Signal and PBCH (physical broadcast channel) Block (SSB) shared RACH Occasion (RO) mask index (ssb-SharedRO-MaskIndex) for this partition
The number of consecutive preambles belonging to GroupA (numberOfRA-PreamblesGroupA)
An uplink resource configuration of a MSGA: the uplink resource may be a Physical Uplink Shared Channel (PUSCH).
Feature-specific parameters: it includes one or more of: a signal quality threshold corresponding to a Synchronization Signal and PBCH (physical broadcast channel) block (SSB) (for example, it may be rsrp-ThresholdSSB), a signal quality corresponding to a Synchronization Signal and PBCH (physical broadcast channel) block (SSB), a signal quality threshold corresponding to a MSG3 (for example, it may be rsrp-ThresholdMsg3), a signal quality corresponding to a MSG3, a message power offset corresponding to GroupB (for example, it may be messagePowerOffsetGroupB), a size of random access GroupA (for example, it may be ra-SizeGroupA), and a preamble delta (deltaPreamble). The signal quality may be RSRP, RSRQ, SINR, RSSI, etc.

### Example 3

One embodiment of the present disclosure proposes a method for supporting network self-optimization, which may include that a first entity transmits third information indicating that SDT information is available and/or RACH partition random access information is available to a second entity, so as to inform the second entity that the first entity has the SDT information and/or the RACH partition random access information, so that the second entity may choose whether to acquire the information.

In some implementations, the third information may be included in one or more of: UE-Measurements Available (UE-MeasurementsAvailable), RRC Setup Complete (RRCSetupComplete), RRC Reestablishment Complete (RRCReestablishmentComplete), RRC Reconfiguration Complete (RRCReconfigurationComplete), or RRC Resume Complete (RRCResumeComplete) of RRC; or an other and/or newly defined RRC and/or Xn and/or X2 and/or F1 and/or E1 and/or NG message.

In some implementations, the third information may include one or more of the following fields or related information:
SDT information available: it is used to indicate that the SDT information is available, which represents that there is stored SDT information available. This field may be represented by a single bit, for example, when this bit is 1, it means that the SDT information is available, and when this bit is 0, it means that the SDT information is not available; alternatively, when this bit is 0, it means that the SDT information is available, and when this bit is 1, it means that the SDT information is not available.
SDT report available: it is used to indicate that the SDT report is available, which represents that there is stored SDT report available. This field may be represented by a single bit. For example, when this bit is 1, it means that the SDT report is available, and when this bit is 0, it means that the SDT report is not available; alternatively, when this bit is 0, it means that the SDT report is available, and when this bit is 1, it means that the SDT report is not available.
RACH partition random access information available: it is used to indicate that the RACH partition random access information is available, which represents that there is stored RACH partition random access information available. This field may be represented by a single bit. For example, when this bit is 1, it means that the RACH partition random access information is available, and when this bit is 0, it means that the RACH partition random access information is not available; alternatively, when this bit is 0, it means that the RACH partition random access information is available, and when this bit is 1, it means that the RACH partition random access information is not available.
RACH partition report available: it is used to indicate that the RACH partition report is available, which represents that there is stored RACH partition report available. This field may be represented by a single bit. For example, when this bit is 1, it means that the RACH partition report is available, and when this bit is 0, it means that the RACH partition report is not available; alternatively, when this bit is 0, it means that the RACH partition report is available, and when this bit is 1, it means that the RACH partition report is not available.

In some implementations, the second entity may transmit fourth information including a request for SDT information and/or RACH partition random access information to the first entity according to its own situation and/or according to the received information indicating that the SDT information is available and/or the RACH partition random access information is available, so as to request the first entity to transmit and/or report the SDT information and/or the RACH partition random access information, so that the second entity may obtain the SDT information and/or the RACH partition random access information and make a self-optimization decision, and/or the second entity forwards the received information to other entities for the other entities to make a self-optimization decision.

In some implementations, the fourth information may be included in one or more of: UEInformationRequest of RRC, or an other and/or newly defined RRC and/or Xn and/or X2 and/or F1 and/or E1 and/or NG message.

In some implementations, the fourth information may include one or more of the following fields or related information:
A request for SDT information: it is used to request the SDT information and/or indicate whether it is required to report the SDT information. This field may be represented by a single bit. For example, when this bit is 1, it means that SDT information is requested and/or needs to be reported, and when this bit is 0, it means that SDT information is not requested and/or needs not to be reported; alternatively, when this bit is 0, it means that SDT information is requested and/or needs to be reported, and when this bit is 1, it means that SDT information is not requested and/or needs not to be reported.
A request for an SDT Report: it is used to request the SDT report and/or indicate whether it is required to report the SDT report. This field may be represented by a single bit. For example, when this bit is 1, it means that SDT report is requested and/or needs to be reported, and when this bit is 0, it means that SDT report is not requested and/or needs not to be reported; alternatively, when this bit is 0, it means that SDT report is requested and/or needs to be reported, and when this bit is 1, it means that SDT report is not requested and/or needs not to be reported.
A request for RACH partition random access information: it is used to request RACH partition random access information and/or indicate whether it is required to report the RACH partition random access information. This field may be represented by a single bit. For example, when this bit is 1, it means that the RACH partition random access information is requested and/or needs to be reported, and when this bit is 0, it means that the RACH partition random access information is not requested and/ or needs not to be reported; alternatively, when this bit is 0, it means that the RACH partition random access information is requested and/or needs to be reported, and when this bit is 1, it means that the RACH partition random access information is not requested and/or needs not to be reported.
A request for a RACH partition report: it is used to request a RACH partition report and/or indicate whether it is required to report the RACH partition report. This field may be represented by a single bit. For example, when this bit is 1, it means that the RACH partition report is requested and/or needs to be reported; and when this bit is 0, it means that the RACH partition report is not requested and/or needs not to be reported; alternatively, when this bit is 0, it means that the RACH partition report is requested and/or needs to be reported, and when this bit is 1, it means that the RACH partition report is not requested and/or needs not to be reported.

### Example 4

One embodiment of the present disclosure proposes a method for supporting network self-optimization, which may include that a first entity transmits fifth information including SDT configuration information and/or RACH partition configuration information to a second entity to provide reference information for the second entity to perform SDT and/or RACH partition configuration to avoid resource configuration collision, etc., or the second entity may transmit the received SDT configuration information and/or RACH partition configuration information to other entities to provide reference information for the other entities to perform SDT and/or RACH partition configuration to avoid resource configuration collision, etc.

In some implementations, the fifth information may be included in one or more of: an XN SETUP REQUEST message or an XN SETUP RESPONSE message of Xn; an ENB CONFIGURATION UPDATE message or an ENB CONFIGURATION UPDATE ACKNOWLEDGE message or an EN-DC CONFIGURATION UPDATE message or an EN-DC CONFIGURATION UPDATE ACKNOWLEDGE message of X2; an NG-RAN NODE CONFIGURATION UPDATE message or an NG-RAN NODE CONFIGURATION UPDATE ACKNOWLEDGE message of Xn; a RESET REQUEST message of X2 or Xn; a MOBILITY CHANGE REQUEST message of X2; a F1 SETUP REQUEST message or F1 SETUP RESPONSE message or GNB-DU CONFIGURATION UPDATE message or GNB-DU CONFIGURATION UPDATE ACKNOWLEDGE message or GNB-CU CONFIGURATION UPDATE message or GNB-CU CONFIGURATION UPDATE ACKNOWLEDGE message or GNB-DU RESOURCE COORDINATION REQUEST message or GNB-DU RESOURCE COORDINATION RESPONSE of F1; a RESOURCE STATUS REQUEST message of X2 or Xn or F1 or E1 or an EN-DC RESOURCE STATUS REQUEST message of X2; or an UPLINK RAN CONFIGURATION TRANSFER message or a DOWNLINK RAN CONFIGURATION TRANSFER message of NG; or an other and/or newly defined RRC and/or Xn and/or X2 and/or F1 and/or E1 and/or NG message.

In some implementations, the fifth information may include one or more of the following fields or related information:
Node identification: it is used to identify a node corresponding to the configuration information.
Cell identification: it is used to identify a cell corresponding to the configuration information.
SDT configuration information for a random access: it is used to indicate SDT configuration information for a random access. This information may include one or more of:
A RSRP threshold corresponding to the SDT (sdt-RSRP-Threshold)
A logical channel state reporting delay timer corresponding to the SDT (sdt-LogicalChannelSR-DelayTimer)
A data volume threshold corresponding to the SDT (sdt-Data Volume Threshold)
An SDT timer value (for example, T319a)
An acceptable value and/or a range of the acceptable value of the SDT configuration information for a random access: it is used to indicate an acceptable value and/or a range of the acceptable value of the SDT configuration information for a random access. Here, the range of the acceptable value may include, for example, a maximum value and/or a minimum value. This field may be an acceptable value and/or a range of the acceptable value of one or more of the following information:
A RSRP threshold corresponding to the SDT (sdt-RSRP-Threshold)
A logical channel state reporting delay timer corresponding to the SDT (sdt-LogicalChannelSR-DelayTimer)
A data volume threshold corresponding to the SDT (sdt-Data Volume Threshold)
An SDT timer value (for example, T319a)
A RACH partition configuration: it is used to indicate the RACH partition configuration applied when performing the random access. The configuration may include one or more of:
A feature combination: it is used to indicate features the configuration is applicable to. The features may include one or more of: RedCap, SDT (or smallData), slice (or slice group), Coverage Enhancement, etc.
A start preamble for this partition (startPreambleForThisPartition)
The number of preambles for this partition (numberOfPreamblesForThisPartition)
A Synchronization Signal and PBCH (physical broadcast channel) Block (SSB) shared RACH Occasion (RO) mask index (ssb-SharedRO-MaskIndex) for this partition
The number of consecutive preambles belonging to GroupA (numberOfRA-PreamblesGroupA)
An uplink resource configuration of a MSGA: the uplink resource may be a Physical Uplink Shared Channel (PUSCH).
Feature-specific parameters: it includes one or more of: a signal quality threshold corresponding to a Synchronization Signal and PBCH (physical broadcast channel) block (SSB) (for example, it may be rsrp-ThresholdSSB), a signal quality threshold corresponding to a MSG3 (for example, it may be rsrp-ThresholdMsg3), a message power offset corresponding to GroupB (for example, it may be messagePowerOffsetGroupB), a size of random access GroupA (for example, it may be ra-SizeGroupA), and a preamble delta (deltaPreamble). The signal quality may be RSRP, RSRQ, SINR, RSSI, etc.
An acceptable value and/or a range of the acceptable value of a RACH partition configuration: it is used to indicate the acceptable value and/or the range of the acceptable value of the RACH partition configuration information. Here, the range of the acceptable value may include, for example, a maximum value and/or a minimum value. This field may be an acceptable value and/or a range of the acceptable value of one or more of the following information:
A feature combination: it is used to indicate features the configuration is applicable to. The features may include one or more of: RedCap, SDT (or smallData), slice (or slice group), Coverage Enhancement, etc.
A start preamble for this partition (startPreambleForThisPartition)
The number of preambles for this partition (numberOfPreamblesForThisPartition)
A Synchronization Signal and PBCH (physical broadcast channel) Block (SSB) shared RACH Occasion (RO) mask index (ssb-SharedRO-MaskIndex) for this partition
The number of consecutive preambles belonging to GroupA (numberOfRA-PreamblesGroupA)
An uplink resource configuration of a MSGA: the uplink resource may be a Physical Uplink Shared Channel (PUSCH).
Feature-specific parameters: a signal quality threshold corresponding to a Synchronization Signal and PBCH (physical broadcast channel) block (SSB) (for example, it may be rsrp-ThresholdSSB), a signal quality threshold corresponding to a MSG3 (for example, it may be rsrp-ThresholdMsg3), a message power offset corresponding to GroupB (for example, it may be messagePowerOffsetGroupB), a size of random access GroupA (for example, it may be ra-SizeGroupA), and a preamble delta (deltaPreamble). The signal quality may be RSRP, RSRQ, SINR, RSSI, etc.

In some implementations, after receiving fifth information from the first entity, the second entity may transmit fifth information of the second entity (for example, including SDT configuration information and/or RACH partition configuration information associated with the second entity) to the first entity according to its own situation, in order to provide reference information for the configuration of SDT and/or RACH partition of the first entity, or the first entity may transmit the received SDT configuration information and/or RACH partition configuration information to other entities to provide reference information for the configuration of SDT and/or RACH partition of other entities.

The methods performed by the first entity and/or the second entity in the wireless communication system according to embodiments of the present disclosure may be used for network self-optimization decision. the network self-optimization decision mentioned in the present disclosure may include one or more of network energy saving, load balancing, coverage optimization, mobility optimization and/or management, network configuration formulation and/or network configuration updating, etc.

In addition, results and reports in the present disclosure may refer to each other.

Exemplary embodiments of the present disclosure are further described below with reference to the accompanying drawings.

The text and drawings are provided as examples only to help understand the present disclosure. They should not be construed as limiting the scope of the present disclosure in any way. Although certain embodiments and examples have been provided, based on the present disclosure herein, it is obvious to those skilled in the art that changes may be made to the illustrated embodiments and examples without departing from the scope of the present disclosure.

FIG. 5 illustrates a schematic diagram of a method for supporting network self-optimization according to embodiments of the present disclosure. Specifically, FIG. 5 shows a process of exchanging SDT information and/or RACH partition random access information between two entities, so that a second entity may obtain SDT information and/or RACH partition random access information and make a self-optimization decision and/or update configurations, etc. In some implementations, for example, the first entity may be a UE, and the second entity may be a gNB or gNB-CU or gNB-DU or gNB CU-CP or gNB CU-UP or en-gNB or eNB or ng-eNB. In other implementations, for example, the first entity may be a gNB or gNB-CU or gNB-DU or gNB CU-CP or gNB CU-UP or en-gNB or eNB or ng-eNB, and the second entity may be a gNB or gNB-CU or gNB-DU or gNB CU-CP or gNB CU-UP or en-gNB or eNB or ng-eNB. In still other implementations, for example, the first entity may be an AMF or SMF or MME, and the second entity may be a gNB or gNB-CU or gNB CU-CP or en-gNB or eNB or ng-eNB. In yet other implementations, for example, the first entity may be a gNB or gNB-CU or gNB CU-CP or en-gNB or eNB or ng-eNB, and the second entity may be an AMF or SMF or MME.

Operation 501: the first entity reports SDT information and/or RACH partition random access information to the second entity. The SDT information may be the aforementioned first information. The RACH partition random access information may be the aforementioned second information.

Operation 502: the second entity makes a self-optimization decision and/or updates configurations and the like based on the received SDT information and/or RACH partition random access information.

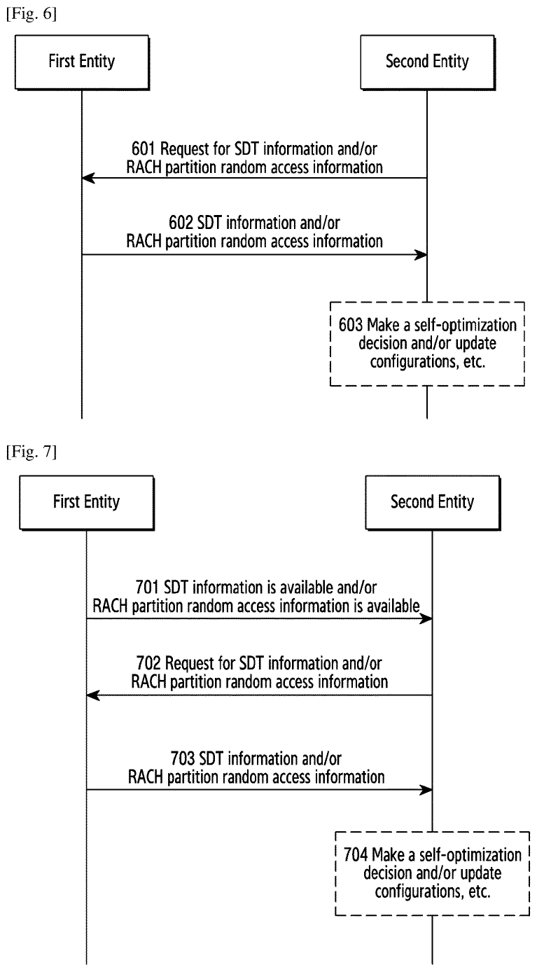

FIG. 6 illustrates a schematic diagram of a method for supporting network self-optimization according to embodiments of the present disclosure. Specifically, FIG. 6 shows a process of exchanging SDT information and/or RACH partition random access information between two entities, so that a second entity may obtain SDT information and/or RACH partition random access information and make a self-optimization decision and/or update configurations, etc. In some implementations, for example, the first entity may be a UE, and the second entity may be a gNB or gNB-CU or gNB-DU or gNB CU-CP or gNB CU-UP or en-gNB or eNB or ng-eNB. In other implementations, for example, the first entity may be a gNB or gNB-CU or gNB-DU or gNB CU-CP or gNB CU-UP or en-gNB or eNB or ng-eNB, and the second entity may be a gNB or gNB-CU or gNB-DU or gNB CU-CP or gNB CU-UP or en-gNB or eNB or ng-eNB. In still other implementations, for example, the first entity may be an AMF or SMF or MME, and the second entity may be a gNB or gNB-CU or gNB CU-CP or en-gNB or eNB or ng-eNB. In yet other implementations, for example, the first entity may be a gNB or gNB-CU or gNB CU-CP or en-gNB or eNB or ng-eNB, and the second entity may be an AMF or SMF or MME.

Operation 601: the second entity transmits a request for SDT information and/or RACH partition random access information to the first entity. The request for the SDT information and/or the RACH partition random access information may be the afore-mentioned fourth information.

Operation 602: the first entity reports SDT information and/or RACH partition random access information to the second entity. The SDT information may be the aforementioned first information. The RACH partition random access information may be the aforementioned second information.

Operation 603: the second entity makes a self-optimization decision and/or updates configurations and the like based on the received SDT information and/or RACH partition random access information.

FIG. 7 illustrates a schematic diagram of a method for supporting network self-optimization according to embodiments of the present disclosure. Specifically, FIG. 7 shows a process of exchanging SDT information and/or RACH partition random access information between two entities, so that a second entity may obtain SDT information and/or RACH partition random access information and make a self-optimization decision and/or update configurations, etc. In some implementations, for example, the first entity may be a UE, and the second entity may be a gNB or gNB-CU or gNB-DU or gNB CU-CP or gNB CU-UP or en-gNB or eNB or ng-eNB. In other implementations, for example, the first entity may be a gNB or gNB-CU or gNB-DU or gNB CU-CP or gNB CU-UP or en-gNB or eNB or ng-eNB, and the second entity may be a gNB or gNB-CU or gNB-DU or gNB CU-CP or gNB CU-UP or en-gNB or eNB or ng-eNB. In still other implementations, for example, the first entity may be an AMF or SMF or MME, and the second entity may be a gNB or gNB-CU or gNB CU-CP or en-gNB or eNB or ng-eNB. In yet other implementations, for example, the first entity may be a gNB or gNB-CU or gNB CU-CP or en-gNB or eNB or ng-eNB, and the second entity may be an AMF or SMF or MME.

Operation 701: the first entity transmits information indicating that SDT information is available and/or RACH partition random access information is available to a second entity, so as to inform the second entity that the first entity has the SDT information and/or the RACH partition random access information. The information indicating that the SDT information is available and/or the RACH partition random access information is available may be the aforementioned third information.

Operation 702: the second entity transmits a request for SDT information and/or RACH partition random access information to the first entity. The request for the SDT information and/or the RACH partition random access information may be the afore-mentioned fourth information.

Operation 703: the first entity reports SDT information and/or RACH partition random access information to the second entity. The SDT information may be the aforementioned first information. The RACH partition random access information may be the aforementioned second information.

Operation 704: the second entity makes a self-optimization decision and/or updates configurations and the like based on the received SDT information and/or RACH partition random access information.

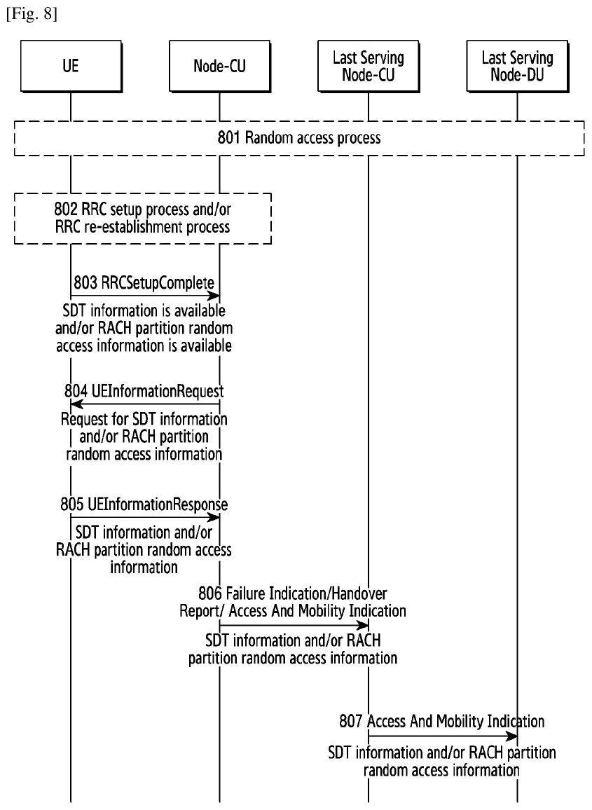

FIG. 8 illustrates a schematic diagram of a method for supporting network self-optimization according to embodiments of the present disclosure. Specifically, FIG. 8 shows a process of exchanging SDT information and/or RACH partition random access information among a user, a node and a last serving node, so that the last serving node may obtain SDT information and/or RACH partition random access information, and may make configuration adjustment and make a self-optimization decision. As mentioned above, a node may be a base station, which may include a central unit (CU) and a distributed unit (DU), and the CU may further include a user plane (UP) and a control plane (CP).

Operation 801: the UE performs a random access process with the last serving node (which may also be the CU of the last serving node and/or the DU of the last serving node).

Operation 802: the UE performs a RRC setup process and/or RRC re-establishment process with the node (or the CU of the node).

Operation 803: the UE transmits information indicating that SDT information is available and/or RACH partition random access information is available to the node (which may also be the CU of the node), so as to inform the node (which may also be the CU of the node) that SDT information and/or RACH partition random access information are available at the UE. The information indicating that the SDT information is available and/or the RACH partition random access information is available may be the aforementioned third information. The information indicating that the SDT information is available and/or the RACH partition random access information is available may be transmitted through a RRC Setup Complete (RRCSetupComplete) message.

Operation 804: the node (which may also be the CU of the node) transmits a request for SDT information and/or RACH partition random access information to the UE to request the UE to report the SDT information and/or the RACH partition random access information. The request for the SDT information and/or the RACH partition random access information may be the aforementioned fourth information. The request for the SDT information and/or the RACH partition random access information may be transmitted through a UE Information Request (UEInformationRequest) message.

Operation 805: the UE transmits SDT information and/or RACH partition random access information to the node (or the CU of the node). The SDT information may be the aforementioned first information. The RACH partition random access information may be the aforementioned second information. The SDT information and/or the RACH partition random access information may be transmitted through a UE Information Response (UEInformationResponse) message.

Operation 806: the node (which may also be the CU of the node) transmits SDT information and/or RACH partition random access information to the last serving node (which may also be the CU of the last serving node). The SDT information may be the aforementioned first information. The RACH partition random access information may be the aforementioned second information. The SDT information and/or the RACH partition random access information may include all information and/or part of information in operation 805. The SDT information and/or the RACH partition random access information may be transmitted through a Failure Indication and/or a Handover Report and/or an Access And Mobility Indication message.

Operation 807: the CU of the last serving node transmits SDT information and/or RACH partition random access information to the DU of the last serving node. The SDT information may be the aforementioned first information. The RACH partition random access information may be the aforementioned second information. The SDT information and/or the RACH partition random access information may include all information and/or part of information in operation 806. The SDT information and/or the RACH partition random access information may be transmitted through an Access And Mobility Indication message.

The last serving node (which may also be the CU of the last serving node or the DU of the last serving node) may make a self-optimizing decision and/or update configurations based on the received SDT information and/or RACH partition random access information.

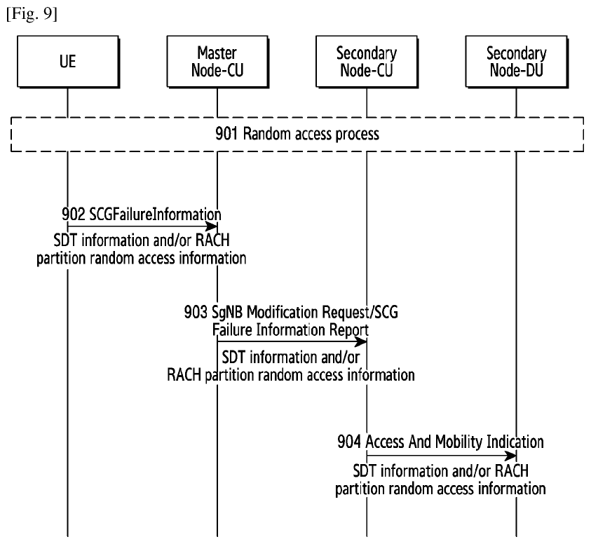

FIG. 9 illustrates a schematic diagram of a method for supporting network self-optimization according to embodiments of the present disclosure. Specifically, FIG. 9 shows a process of exchanging SDT information and/or RACH partition random access information among a UE, a master node and a secondary node in a case of dual-connectivity in which the UE performs a random access with the secondary node, so that the secondary node may obtain SDT information and/or RACH partition random access information, in order for the secondary node to make configuration adjustment and make a self-optimization decision.

Operation 901: the UE performs a random access process with a secondary node (which may also be the CU of the secondary node and/or the DU of the secondary node).

Operation 902: the UE transmits SDT information and/or RACH partition random access information to the master node (which may also be the CU of the master node). The SDT information may be the aforementioned first information. The RACH partition random access information may be the aforementioned second information.

The SDT information and/or the RACH partition random access information may be transmitted through an SCG Failure Information (SCGFailureInformation) message.

Operation 903: the master node (which may also be the CU of the master node) transmits SDT information and/or RACH partition random access information to the secondary node (which may also be the CU of the secondary node). The SDT information may be the aforementioned first information. The RACH partition random access information may be the aforementioned second information. The SDT information and/or the RACH partition random access information may include all information and/or part of information in step 902. The SDT information and/or RACH partition random access information may be transmitted through a SgNB Modification Request and/or an SCG Failure Information Report message.

Operation 904: the CU of the secondary node transmits SDT information and/or RACH partition random access information to the DU of the secondary node. The SDT information may be the aforementioned first information. The RACH partition random access information may be the aforementioned second information. The SDT information and/or the RACH partition random access information may include all information and/or part of information in step 903. The SDT information and/or the RACH partition random access information may be transmitted through an Access And Mobility Indication message.

The master node (which may also be the CU of the master node) and the secondary node (which may also be the CU of the secondary node or the DU of the secondary node) may make a self-optimization decision and/or update configurations based on the received SDT information and/or RACH partition random access information.

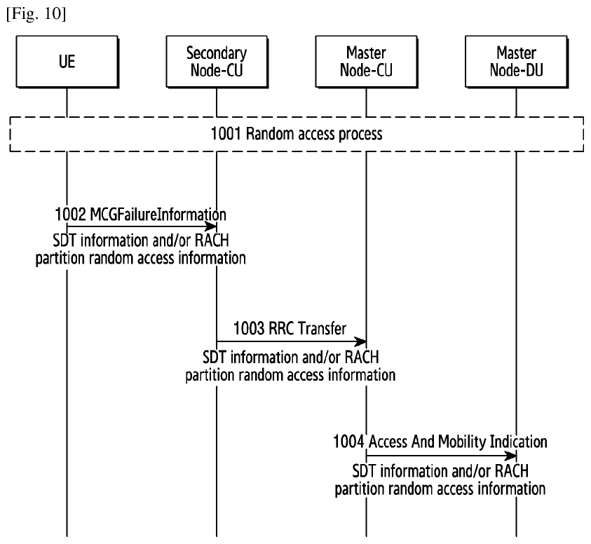

FIG. 10 illustrates a schematic diagram of a method for supporting network self-optimization according to embodiments of the present disclosure. Specifically, FIG. 10 shows a process of exchanging SDT information and/or RACH partition random access information among a UE, a master node and a secondary node in a case of dual-connectivity in which the UE performs a random access with the master node, so that the master node may obtain SDT information and/or RACH partition random access information, in order for the master node to make configuration adjustment and make a self-optimization decision.

Operation 1001: the UE performs a random access process with the master node (which may also be the CU of the master node and/or the DU of the master node).

Operation 1002: the UE transmits SDT information and/or RACH partition random access information to the secondary node (which may also be the CU of the secondary node). The SDT information may be the aforementioned first information. The RACH partition random access information may be the aforementioned second information.

The SDT information and/or the RACH partition random access information may be transmitted through a Master Cell Group Failure Information (MCGFailureInformation) message.

Operation 1003: the secondary node (which may also be the CU of the secondary node) transmits SDT information and/or RACH partition random access information to the master node (which may also be the CU of the master node). The SDT information may be the aforementioned first information. The RACH partition random access information may be the aforementioned second information. The SDT information and/ or the RACH partition random access information may include all information and/or part of information in step 1002. The SDT information and/or the RACH partition random access information may be transmitted through a RRC Transfer message.

Operation 1004: the CU of the master node transmits SDT information and/or RACH partition random access information to the DU of the master node. The SDT information may be the aforementioned first information. The RACH partition random access information may be the aforementioned second information. The SDT information and/or the RACH partition random access information may include all information and/or part of information in operation 1003. The SDT information and/or the RACH partition random access information may be transmitted through an Access And Mobility Indication message.

The master node (which may be the CU of the master node or the DU of the master node) may make a self-optimization decision and/or update configurations based on the received SDT information and/or RACH partition random access information.

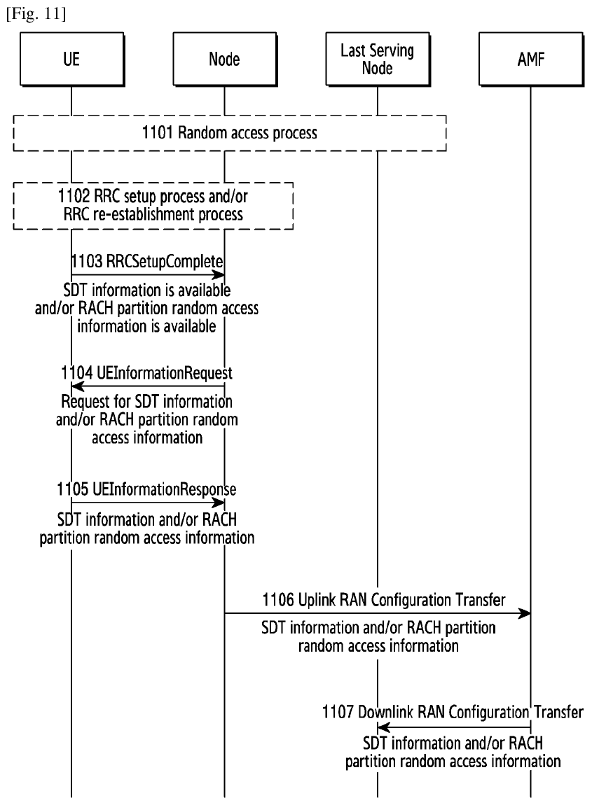

FIG. 11 illustrates a schematic diagram of a method for supporting network self-optimization according to embodiments of the present disclosure. Specifically, FIG. 11 shows a process of exchanging SDT information and/or RACH partition random access information among a user, a node, a last serving node and an AMF, so that the last serving node may obtain SDT information and/or RACH partition random access information, and make configuration adjustment and make a self-optimization decision.

Operation 1101: the UE performs a random access process with the last serving node (which may also be the CU of the last serving node and/or the DU of the last serving node).

Operation 1102: the UE performs a RRC setup process and/or RRC re-establishment process with the node (or the CU of the node).

Operation 1103: the UE transmits information indicating that SDT information is available and/or RACH partition random access information is available to the node (which may also be the CU of the node), so as to inform the node (which may also be the CU of the node) that the SDT information and/or the RACH partition random access information are available at the UE. The information indicating that the SDT information is available and/or the RACH partition random access information is available may be the aforementioned third information. The information indicating that the SDT information and/or the RACH partition random access information are available may be transmitted through a RRC Setup Complete (RRCSetupComplete) message.

Operation 1104: the node (which may also be the CU of the node) transmits a request for SDT information and/or RACH partition random access information to the UE to request the UE to report the SDT information and/or the RACH partition random access information. The request for the SDT information and/or the RACH partition random access information may be the aforementioned fourth information. The request for the SDT information and/or the RACH partition random access information may be transmitted through a UE Information Request (UEInformationRequest) message.

Operation 1105: the UE transmits SDT information and/or RACH partition random access information to the node (or the CU of the node). The SDT information may be the aforementioned first information. The RACH partition random access information may be the aforementioned second information. The SDT information and/or the RACH partition random access information may be transmitted through a UE Information Response (UEInformationResponse) message.

Operation 1106: the node (or the CU of the node) transmits SDT information and/or RACH partition random access information to the AMF. The SDT information may be the aforementioned first information. The RACH partition random access information may be the aforementioned second information. The SDT information and/or the RACH partition random access information may include all information and/or part of information in step 1105. The SDT information and/or the RACH partition random access information may be transmitted through an Uplink RAN Configuration Transfer message.

Operation 1107: the AMF transmits SDT information and/or RACH partition random access information to the last serving node (or the CU of the last serving node). The SDT information may be the aforementioned first information. The RACH partition random access information may be the aforementioned second information. The SDT information and/or the RACH partition random access information may include all information and/or part of information in operation 1106. The SDT information and/or the RACH partition random access information may be transmitted through a Downlink RAN Configuration Transfer message.

The CU of the last serving node may also transmit all and/or part of the received SDT information and/or RACH partition random access information to the DU of the last serving node.

The last serving node (which may also be the CU of the secondary node or the DU of the secondary node) may make a self-optimization decision and/or update configurations based on the received SDT information and/or RACH partition random access information.

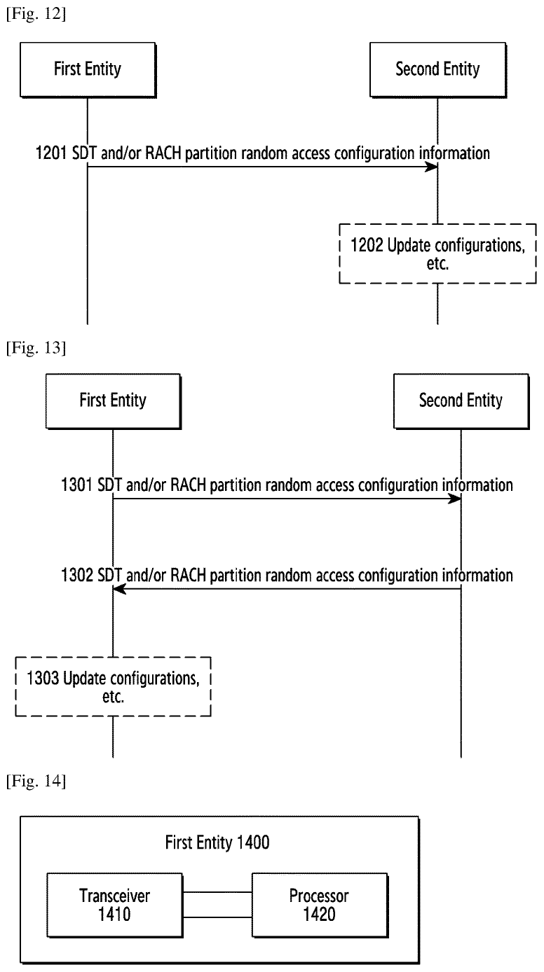

FIG. 12 illustrates a schematic diagram of a method for supporting network self-optimization according to embodiments of the present disclosure. Specifically, FIG. 12 shows a process of exchanging SDT configuration information and/or RACH partition random access configuration information (that is, the above-mentioned SDT configuration information and/or RACH partition configuration information) between two entities, so that a second entity may obtain the SDT configuration information and/or the RACH partition random access configuration information to update configurations, etc. In some implementations, for example, the first entity may be a gNB or gNB-CU or gNB-DU or gNB CU-CP or gNB CU-UP or en-gNB or eNB or ng-eNB, and the second entity may be a gNB or gNB-CU or gNB-DU or gNB CU-CP or gNB CU-UP or en-gNB or eNB or ng-eNB. In other implementations, for example, the first entity may be an AMF or SMF or MME, and the second entity may be a gNB or gNB-CU or gNB CU-CP or en-gNB or eNB or ng-eNB. In yet other implementations, for example, the first entity may be a gNB or gNB-CU or gNB CU-CP or en-gNB or eNB or ng-eNB, and the second entity may be an AMF or SMF or MME.

Operation 1201: the first entity transmits SDT configuration information and/or RACH partition random access configuration information to the second entity. The SDT configuration information and/or the RACH partition random access configuration information may be the aforementioned fifth information.

Operation 1202: the second entity updates configurations and the like based on the received SDT configuration information and/or RACH partition random access configuration information.

FIG. 13 illustrates a schematic diagram of a method for supporting network self-optimization according to embodiments of the present disclosure. Specifically, FIG. 13 shows a process of exchanging SDT configuration information and/or RACH partition random access configuration information between two entities, so that the first entity may negotiate the SDT configuration information and/or the RACH partition random access configuration information with the second entity, and the first entity may update configurations, etc. In some implementations, for example, the first entity may be a gNB or gNB-CU or gNB-DU or gNB CU-CP or gNB CU-UP or en-gNB or eNB or ng-eNB, and the second entity may be a gNB or gNB-CU or gNB-DU or gNB CU-CP or gNB CU-UP or en-gNB or eNB or ng-eNB. In other implementations, for example, the first entity may be an AMF or SMF or MME, and the second entity may be a gNB or gNB-CU or gNB CU-CP or en-gNB or eNB or ng-eNB. In yet other implementations, for example, the first entity may be a gNB or gNB-CU or gNB CU-CP or en-gNB or eNB or ng-eNB, and the second entity may be an AMF or SMF or MME.

Operation 1301: the first entity transmits SDT configuration information and/or RACH partition random access configuration information to the second entity. The SDT configuration information and/or the RACH partition random access configuration information may be the aforementioned fifth information.

Operation 1302: the second entity transmits SDT configuration information and/or RACH partition random access configuration information associated with the second entity to the first entity. The SDT configuration information and/or the RACH partition random access configuration information may also be the aforementioned fifth information.

Operation 1303: the first entity updates configurations and the like based on the SDT configuration information and/or the RACH partition random access configuration information negotiated in operation 1301 and/or operation 1302.

Next, FIG. 14 illustrates a schematic diagram of a first entity 1400 according to embodiments of the present disclosure.

As shown in FIG. 14, the first entity (or a first entity device) 1400 according to embodiments of the present disclosure may include a transceiver 1410 and a processor 1420. The transceiver 1410 may be configured to transmit and receive signals. The processor 1420 may be coupled to the transceiver 1410 and may be configured to (e.g., control the transceiver 1410 to) perform methods performed by a first entity according to embodiments of the present disclosure.

FIG. 15 illustrates a schematic diagram of a second entity 1500 according to embodiments of the present disclosure.

As shown in FIG. 15, the second entity (or a second entity device) 1500 according to embodiments of the present disclosure may include a transceiver 1510 and a processor 1520. The transceiver 1510 may be configured to transmit and receive signals. The processor 1520 may be coupled to the transceiver 1510 and may be configured to (e.g., control the transceiver 1510 to) perform methods performed by a second entity according to embodiments of the present disclosure. A processor may also be called a controller.

FIG. 16 illustrates a block diagram of a terminal (or a user equipment (UE)), according to embodiments of the present disclosure. FIG. 16 corresponds to the example of the UE of FIG. 101.

As shown in FIG. 16, the UE according to an embodiment may include a transceiver 1610, a memory 1620, and a processor 1630. The transceiver 1610, the memory 1620, and the processor 1630 of the UE may operate according to a communication method of the UE described above. However, the components of the UE are not limited thereto. For example, the UE may include more or fewer components than those described above. In addition, the processor 1630, the transceiver 1610, and the memory 1620 may be implemented as a single chip. Also, the processor 1630 may include at least one processor.

The transceiver 1610 collectively refers to a UE receiver and a UE transmitter, and may transmit/receive a signal to/from a base station or a network entity. The signal transmitted or received to or from the base station or a network entity may include control information and data. The transceiver 1610 may include a RF transmitter for up-converting and amplifying a frequency of a transmitted signal, and a RF receiver for amplifying low-noise and down-converting a frequency of a received signal.

However, this is only an example of the transceiver 1610 and components of the transceiver 1610 are not limited to the RF transmitter and the RF receiver.

Also, the transceiver 1610 may receive and output, to the processor 1630, a signal through a wireless channel, and transmit a signal output from the processor 1630 through the wireless channel.

The memory 1620 may store a program and data required for operations of the UE.

Also, the memory 1620 may store control information or data included in a signal obtained by the UE. The memory 1620 may be a storage medium, such as read-only memory (ROM), random access memory (RAM), a hard disk, a CD-ROM, and a DVD, or a combination of storage media.

The processor 1630 may control a series of processes such that the UE operates as described above. For example, the transceiver 1610 may receive a data signal including a control signal transmitted by the base station or the network entity, and the processor 1630 may determine a result of receiving the control signal and the data signal transmitted by the base station or the network entity.

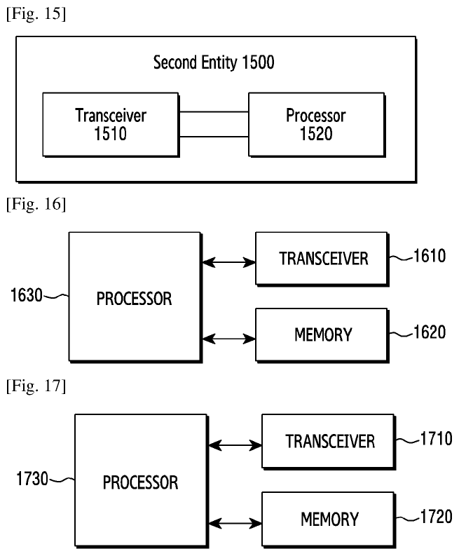

FIG. 17 illustrates a block diagram of a base station, according to embodiments of the present disclosure. FIG. 17 corresponds to the example of the gNB of FIG. 1.

As shown in FIG. 17, the base station according to an embodiment may include a transceiver 1710, a memory 1720, and a processor 1730. The transceiver 1710, the memory 1720, and the processor 1730 of the base station may operate according to a communication method of the base station described above. However, the components of the base station are not limited thereto. For example, the base station may include more or fewer components than those described above. In addition, the processor 1730, the transceiver 1710, and the memory 1720 may be implemented as a single chip. Also, the processor 1730 may include at least one processor.

The transceiver 1710 collectively refers to a base station receiver and a base station transmitter, and may transmit/receive a signal to/from a terminal or a network entity. The signal transmitted or received to or from the terminal or a network entity may include control information and data. The transceiver 1710 may include a RF transmitter for up-converting and amplifying a frequency of a transmitted signal, and a RF receiver for amplifying low-noise and down-converting a frequency of a received signal. However, this is only an example of the transceiver 1710 and components of the transceiver 1710 are not limited to the RF transmitter and the RF receiver.

Also, the transceiver 1710 may receive and output, to the processor V30, a signal through a wireless channel, and transmit a signal output from the processor 1730 through the wireless channel.

The memory 1720 may store a program and data required for operations of the base station. Also, the memory 1720 may store control information or data included in a signal obtained by the base station. The memory 1720 may be a storage medium, such as read-only memory (ROM), random access memory (RAM), a hard disk, a CD-ROM, and a DVD, or a combination of storage media.

The processor 1730 may control a series of processes such that the base station operates as described above. For example, the transceiver 1710 may receive a data signal including a control signal transmitted by the terminal, and the processor 1730 may determine a result of receiving the control signal and the data signal transmitted by the terminal.

In the afore-described embodiments of the present disclosure, elements included in the present disclosure are expressed in a singular or plural form according to the embodiments. However, the singular or plural form is appropriately selected for con-venience of explanation and the present disclosure is not limited thereto. As such, an element expressed in a plural form may also be configured as a single element, and an element expressed in a singular form may also be configured as plural elements.

Embodiments of the present disclosure also provide a computer-readable medium having stored thereon computer-readable instructions which, when executed by a processor, implement any method according to embodiments of the present disclosure.

Various embodiments of the present disclosure may be implemented as computer-readable codes embodied on a computer-readable recording medium from a specific perspective. A computer-readable recording medium is any data storage device that can store data readable by a computer system. Examples of computer-readable recording media may include read-only memory (ROM), random access memory (RAM), compact disk read-only memory (CD-ROM), magnetic tape, floppy disk, optical data storage device, carrier wave (e.g., data transmission via the Internet), etc. Computer-readable recording media can be distributed by computer systems connected via a network, and thus computer-readable codes can be stored and executed in a distributed manner. Furthermore, functional programs, codes and code segments for implementing various embodiments of the present disclosure can be easily explained by those skilled in the art to which the embodiments of the present disclosure are applied.

It will be understood that the embodiments of the present disclosure may be implemented in the form of hardware, software, or a combination of hardware and software. The software may be stored as program instructions or computer-readable codes executable on a processor on a non-transitory computer-readable medium.

Examples of non-transitory computer-readable recording media include magnetic storage media (such as ROM, floppy disk, hard disk, etc.) and optical recording media (such as CD-ROM, digital video disk (DVD), etc.). Non-transitory computer-readable recording media may also be distributed on computer systems coupled to a network, so that computer-readable codes are stored and executed in a distributed manner. The medium can be read by a computer, stored in a memory, and executed by a processor. Various embodiments may be implemented by a computer or a portable terminal including a controller and a memory, and the memory may be an example of a non-transitory computer-readable recording medium suitable for storing program(s) with instructions for implementing embodiments of the present disclosure. The present disclosure may be realized by a program with code for concretely implementing the apparatus and method described in the claims, which is stored in a machine (or computer)-readable storage medium. The program may be electronically carried on any medium, such as a communication signal transmitted via a wired or wireless connection, and the present disclosure suitably includes its equivalents.

What has been described above is only the specific implementation of the present disclosure, but the scope of protection of the present disclosure is not limited thereto. Anyone who is familiar with this technical field may make various changes or substitutions within the technical scope disclosed in the present disclosure, and these changes or substitutions should be covered within the scope of protection of the present disclosure. Therefore, the scope of protection of the present disclosure should be based on the scope of protection of the claims.

1-15. (canceled)

16. A method performed by a user equipment (UE) in a wireless communication system, the method comprising:
receiving, from a base station, a first message requesting a random access (RA) report; and
transmitting, to the base station, a second message including the RA report,
wherein the RA report includes RA information on an RA,
wherein the RA information includes first information on a first feature combination associated with a resource used for the RA, and
wherein the first feature combination includes at least one of a reduced capability (RedCap), a small data transmission (SDT), or a slice.

17. The method of claim 16, wherein the RA information further includes second information on a second feature combination triggered the RA, and
wherein the second feature combination includes at least one of the RedCap, the SDT, or the slice.

18. The method of claim 16, wherein the RA information further includes information on a start preamble for a random access channel (RACH) partition.

19. The method of claim 16, wherein the RA information further includes information on a number of preambles for a random access channel (RACH) partition.

20. A user equipment (UE) in a wireless communication system, the UE comprising:
a transceiver, and
a controller coupled with the transceiver and configured to:
receive, from a base station, a first message requesting a random access (RA) report, and
transmit, to the base station, a second message including the RA report,
wherein the RA report includes RA information on an RA,
wherein the RA information includes first information on a first feature combination associated with a resource used for the RA, and
wherein the first feature combination includes at least one of a reduced capability (RedCap), a small data transmission (SDT), or a slice,

21. The UE of claim 20, wherein the RA information further includes second information on a second feature combination triggered the RA, and
wherein the second feature combination includes at least one of the RedCap, the SDT, or the slice.

22. The UE of claim 20, wherein the RA information further includes information on a start preamble for a random access channel (RACH) partition.

23. The UE of claim 20, wherein the RA information further includes information on a number of preambles for a random access channel (RACH) partition.

24. A method performed by a base station (BS) in a wireless communication system, the method comprising:
transmitting, to a user equipment (UE), a first message requesting a random access (RA) report; and
receiving, from the UE, a second message including the RA report,
wherein the RA report includes RA information on an RA,
wherein the RA information includes first information on a first feature combination associated with a resource used for the RA,
wherein the first feature combination includes at least one of a reduced capability (RedCap), a small data transmission (SDT), or a slice, and
wherein the RA information is for random access channel (RACH) optimization.

25. The method of claim 24, wherein the RA information further includes second information on a second feature combination triggered the RA, and
wherein the second feature combination includes at least one of the RedCap, the SDT, or the slice.

26. The method of claim 24, wherein the RA information further includes information on a start preamble for a RACH partition.

27. The method of claim 24, wherein the RA information further includes information on a number of preambles for a RACH partition.

28. A base station (BS) in a wireless communication system, the BS comprising:
a transceiver, and
a controller coupled with the transceiver and configured to:
transmit, to a user equipment (UE), a first message requesting a random access (RA) report, and
receive, from the UE, a second message including the RA report,
wherein the RA report includes RA information on an RA,
wherein the RA information includes first information on a first feature combination associated with a resource used for the RA,
wherein the first feature combination includes at least one of a reduced capability (RedCap), a small data transmission (SDT), or a slice, and
wherein the RA information is for random access channel (RACH) optimization.

29. The BS of claim 28, wherein the RA information further includes second information on a second feature combination triggered the RA, and
wherein the second feature combination includes at least one of the RedCap, the SDT, or the slice.

30. The BS of claim 28, wherein the RA information further includes information on a start preamble for a RACH partition.

31. The BS of claim 28, wherein the RA information further includes information on a number of preambles for a RACH partition.
